(19) United States
(12) Patent Application Publication
(10) Pub. No.: US 2026/0278752 A1
(43) Pub. Date: Sep. 17, 2026

(54) COMPUTING SYSTEM AND METHOD FOR INPAINTING BACKGROUND OF OUTPUT IMAGE

(71) Applicant: Bytedance Technology Ltd., Grand Cayman (KY)

(72) Inventors: Yumin Jia, Los Angeles, CA (US); Hao Kang, Los Angeles, CA (US); Xin Lu, Los Angeles, CA (US); Qing Yan, Los Angeles, CA (US); Liming Jiang, Los Angeles, CA (US); Zichuan Liu, Los Angeles, CA (US)

(21) Appl. No.: 19/079,064

(22) Filed: Mar. 13, 2025

(51) Int. Cl. G06T 5/77; G06T 5/73; G06T 7/11; G06T 7/194; G06T 11/00; G06V 10/764; G06V 20/70

(52) U.S. Cl. CPC G06T 5/77; G06T 5/73; G06T 7/11; G06T 7/194; G06T 11/00; G06V 10/764; G06V 20/70; G06T 2207/20192; G06T 2210/12

(57) ABSTRACT

A computing system is provided, including processing circuitry configured to receive an input image of an object and a text label corresponding to the input image. The processing circuitry is further configured to input the text label and input image to a vision-language model to generate a text description of features of the object and input the text description to a language model to generate a background prompt and target bounding box information. The processing circuitry is further configured to segment the input image to generate a target segmentation mask region in a shape of the object and generate a mask image including the target segmentation mask region and an infill region. The processing circuitry is further configured to inpaint the infill region based on the input image, the mask image, and the background prompt, to thereby generate the output image.

### BACKGROUND

Creating high-quality, visually appealing, and contextually relevant product images is crucial for capturing consumer attention and effectively communicating brand identity, especially within the realm of digital advertising. Traditionally, this process relies heavily on manual design workflows involving professional graphic designers and photographers. These practices demand advanced design expertise, considerable time investment, and substantial financial resources. While some automated tools exist for basic image editing and enhancement, they often lack the capability to generate fully customized, brand-aligned visuals that balance creativity with contextual relevance. Existing solutions also struggle to deliver diverse visual outputs at scale, limiting their effectiveness in engaging varied target audiences.

### SUMMARY

A computing system is provided herein. In one example, the computing system includes processing circuitry and memory storing instructions that, during execution, cause the processing circuitry to receive an input image of an object and a text label corresponding to the output input of the object. The processing circuitry is further configured to input the text label and the input image to a vision-language model (VLM) to thereby generate a text description of features of the object. The processing circuitry is further configured to input the text description to a language model (LM) to thereby generate a background prompt and target bounding box information. The background prompt includes an attribute of a background of an output image. The processing circuitry is further configured to segment the input image to generate a target segmentation mask region in a shape of the object. The processing circuitry is further configured to generate a mask image including the target segmentation mask region and an infill region. The mask image includes the target segmentation mask region at a scale and position that have been adjusted according to the target bounding box information. The infill region corresponds to the background of the output image. The processing circuitry is further configured to inpaint, via an inpainting model, the infill region based on the input image, the mask image, and the background prompt, to thereby generate the output image. The processing circuitry is further configured to output the output image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic diagram of an example computing system for inpainting background of an output image, according to one example implementation of the present disclosure.

FIG. 2 illustrates a pre-filtering process of an input image performed by a pre-filtering module of the computing system of FIG. 1.

FIG. 3 illustrates a prompt generation process performed by a prompt generation module of the computing system of FIG. 1.

FIG. 4 illustrates a segmentation and mask image generation process performed by a segmentation and mask image generation module of the computing system of FIG. 1.

FIG. 5 illustrates an inpainting process performed by an inpainting model of the computing system of FIG. 1.

FIG. 6 illustrates a post-filtering process of an input image performed by a post-filtering module of the computing system of FIG. 1.

FIGS. 7A and 7B show a flowchart of a computerized method according to one example implementation of the computing system of FIG. 1.

FIG. 8 shows an example computing environment of the present disclosure in which the computing system of FIG. 1 may be enacted.

### DETAILED DESCRIPTION

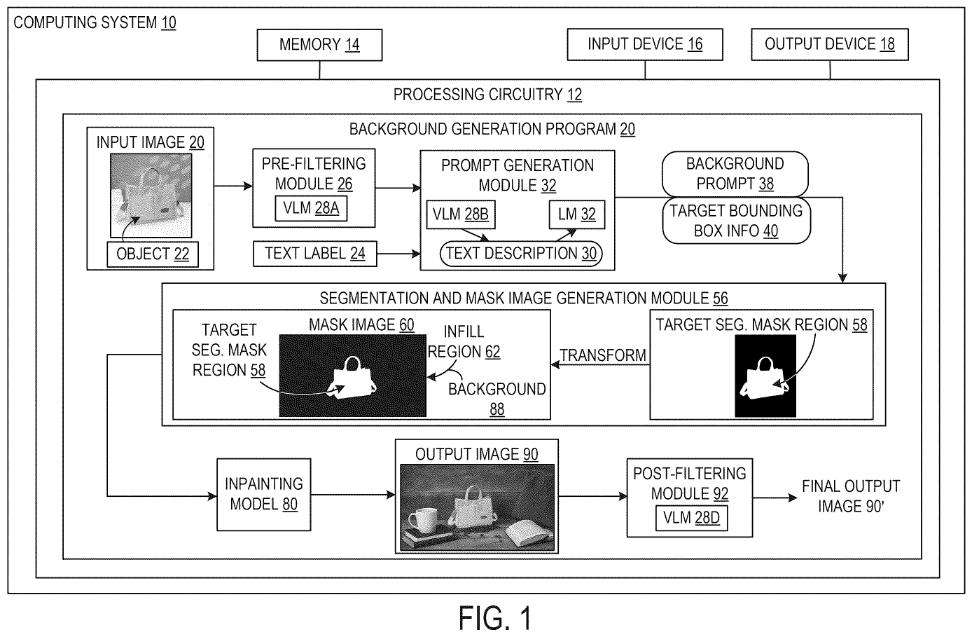

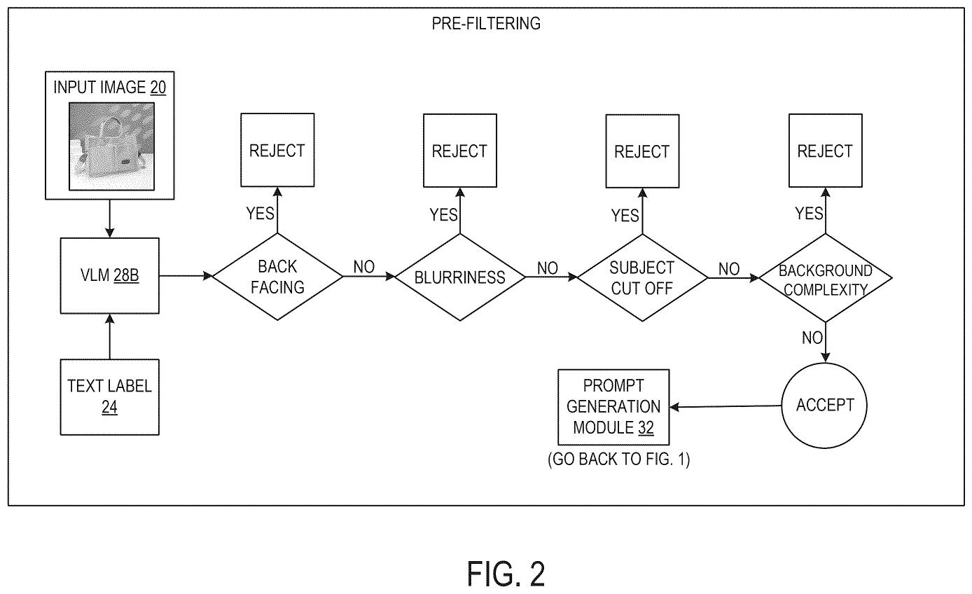

As schematically illustrated in FIG. 1, to address the issues identified above, a computing system 10 for automatically inpainting the background of an output image is provided. The computing system 10 comprises processing circuitry 12, memory 14, one or more input devices 16 for receiving user input, output devices 18 such as a display. The computing system 10 may serve as a client device, which may be a device such as a smartphone, tablet, smartwatch, or personal computer. Furthermore, the computing system 10, including the processing circuitry 12 may be one of a plurality of server devices, and the processing circuitry 12 may be one processor of a single server device or multiple processors of multiple server devices.

The memory 14 stores instructions that, during execution, cause the processing circuitry 12 to receive an input image 20 of an object 22. In the depicted example in FIG. 1, the input image 20 of the object 22 may be an image of a product sold by a store owner, and the object 22 is a bag for sale. The input image 20 to be received may be just one or multiple images of the same object. The processing circuitry 12 is further configured to receive a text label 24. The text label 24 may be the name of the object 22, such as a product name. In the depicted example, the text label 24 is “bag.” The input image 20 and the text label 24 are input to a pre-filtering module 26 for pre-filtering.

FIG. 2 illustrates the pre-filtering process of the input image 20 performed by the pre-filtering module 26. The pre-filtering process analyzes the input images 20 to ensure they are suitable for an inpainting process. It aims to exclude images with back-facing or bottom-facing objects, cropped or incomplete objects, blurry objects, transparency issues, or overly complex backgrounds. A vision-language model (VLM) may be used to assess and score how easily the object can be isolated from the background. As depicted in FIG. 2, the processing circuitry 12 is configured to input the input image 20 of the object 22 and the text label 24 to a vision-language model (VLM) 28A. In response to inputting the input image 20 and the text label 24, the VLM 28A generates a VLM suitability output indicating whether the input image is suitable. The VLM model suitability output can be a classification (suitable/not suitable), a score indicating the ease of subject object isolation (e.g., 24% suitable compared to a suitable threshold of 60%), or a text output (“This image is of low quality and is not suitable”). The VLM 28A is an artificial intelligence model that combines computer vision and natural language processing (NLP) capabilities. The VLM 28A learns to map the relationships between text data and visual data such as images or videos, allowing these models to generate text from visual inputs or understand natural language prompts in the context of visual information. The processing circuitry 12 is further configured to accept or reject the input image 20 based on the VLM suitability output for various criteria. For example, as depicted in FIG. 2, the input image 20 is accepted or rejected depending on whether the input image 20 includes a back-facing or bottom-facing object. The input image 20 is further accepted or rejected based on its level of blurriness. The input image 20 is further accepted or rejected depending on whether the input image 20 includes a cropped or incomplete object. The background complexity of the input image 20 is another factor for acceptance or rejection. Finally, the input image 20 may be accepted or rejected based on transparency issues or the level of object isolation. Through this pre-filtering process, only input images 20 that are accepted for all these factors is utilized for the inpainting workflow. Alternatively, input images 20 with an average score for all these factors that exceeds a predetermined threshold may be filtered and utilized. Furthermore, it will be appreciated that this pre-filtering process can be made optional and omitted.

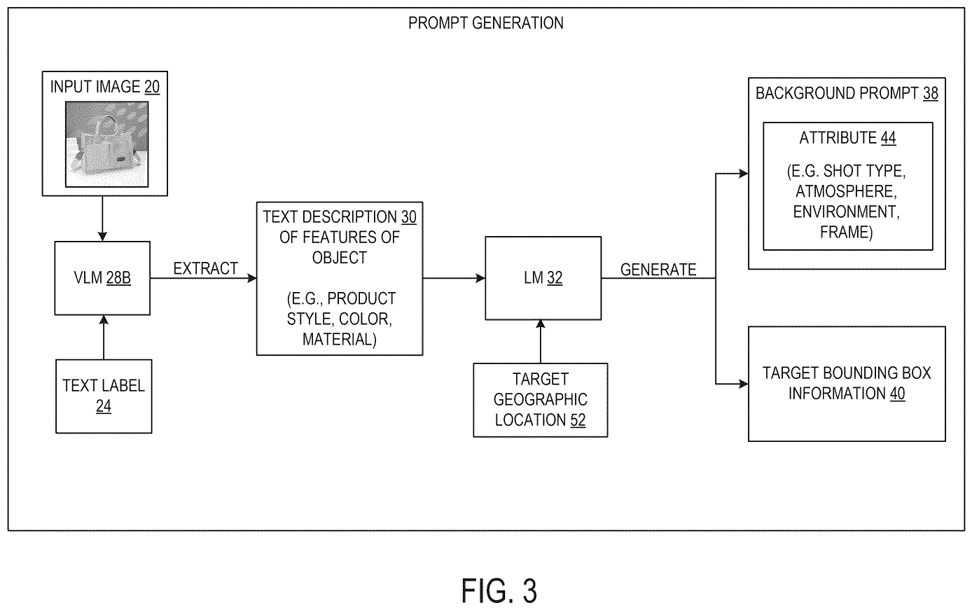

Turning back to FIG. 1, the input image 20 that is accepted by the pre-filtering module 26 is sent to a prompt generation module 32 for prompt generation. Through the prompt generation module 32, the processing circuitry 12 is configured to input the input image 20 and the text label 24 to a vision-language model (VLM) 28B to thereby generate a text description 30 of features of the object 22. The processing circuitry 12 is further configured to input the text description 30 to a language model (LM) 32 to thereby generate a background prompt 38 and target bounding box information 40. The background prompt 38 includes an attribute 44 of a background 88 of an output image 90. FIG. 3 provides a detailed illustration of the prompt generation process performed by the prompt generation module 26 in more detail. As shown in the figure, the input image 20 and the text label 24 are input to the VLM 28B to extract the text description 30 of the features of the object 22. For instance, the text description 30 of the features of the object 22 may include the product style, color, and material of the object 22 (e.g., bag). The extracted text description 30 of the features of the object 22 is input to the LM 32 to generate the background prompt 38 and the target bounding box information 40. A target geographic location 52 in addition to the text description 30 may be input to the LM 32 to generate the background prompt 38 and the target bounding box information 40. For example, the target geographic location 52 may be a specific city, country, or area where the store owner plans to sell the object 22 (e.g., bag). The generated background prompt 38 includes the attribute 44 of the background 88 of an output image 90. The attribute 44 of the background 88 of the output image 90 may be selected from shot type, atmosphere, environment, and/or frame of the background 88, where a single attribute or more than one attribute can be used. The generated background prompt 38 can be tailored to the product's material, use case, and target audience in the target geographic location 52. On the other hand, the generated target bounding box information 40 indicates where the object 22 should appear in the output image 90.

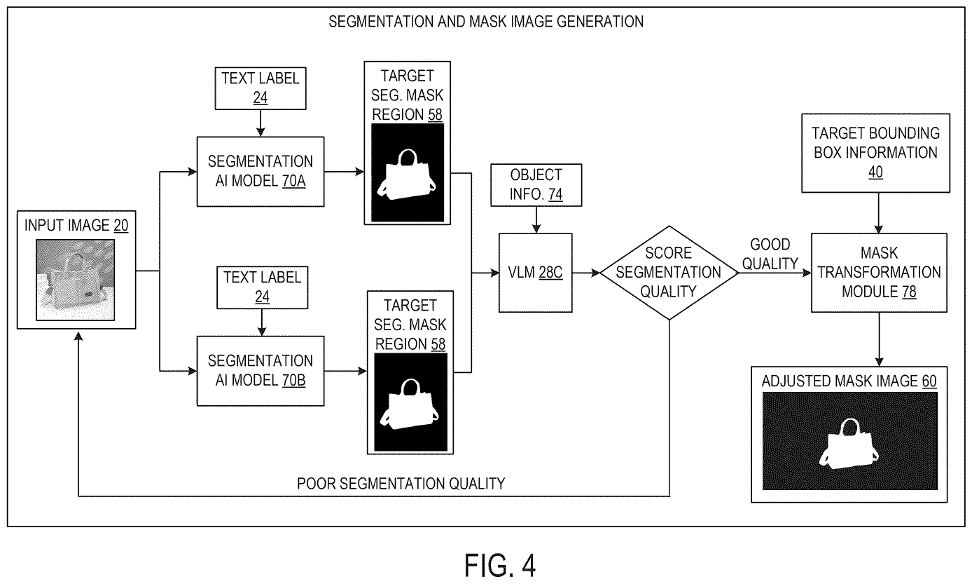

Turning back to FIG. 1, the processing circuitry 12 is further configured to segment, via a segmentation and mask image generation module 56, the input image 20 to generate a target segmentation mask region 58 in a shape of the object 22. The processing circuitry 12 is further configured to generate a mask image 60 including the target segmentation mask region 58 and an infill region 62, in which the mask image 60 includes the target segmentation mask region 58 at a scale and position that have been adjusted according to the target bounding box information 40. The infill region 62 corresponds to the background 88 of the output image 90. FIG. 4 provides a detailed illustration of the segmentation and mask image generation process performed by the segmentation and mask image generation module 56. As shown in the figure, the input image 20 and the text label 24 are input to a segmentation artificial intelligence (AI) model 70 (e.g., SamV2 or rmbg) to extract the object 22 from the input image 20 and create a segmentation mask including the target segmentation mask region 58. Multiple different segmentation AI models 70A, 70B are utilized to create the segmentation mask including the target segmentation mask region 58, since some AI models might not perfectly isolate or accurately outline the object 22. The multiple segmentation masks generated by the AI models 70A and 70B are evaluated by the VLM 28C, and the most accurate segmentation mask including the target segmentation mask region 58 is selected based on the segmentation quality score. The scale and position of the selected segmentation mask is adjusted via a mask transformation module 78 to thereby generate the mask image 60 including the target segmentation mask region 58 and the infill region 62 according to the target bounding box information 40, where the infill region 62 corresponds to the background 88 of the output image 90. The selected segmentation mask can be scaled and positioned to align perfectly with target bounding box information 40 for seamless integration. As illustrated in the figure, the mask image 60 is adjusted with respect to its size, having a larger background, and the object 22 is positioned at a suitable location within the mask image 60 based on target bounding box information 40.

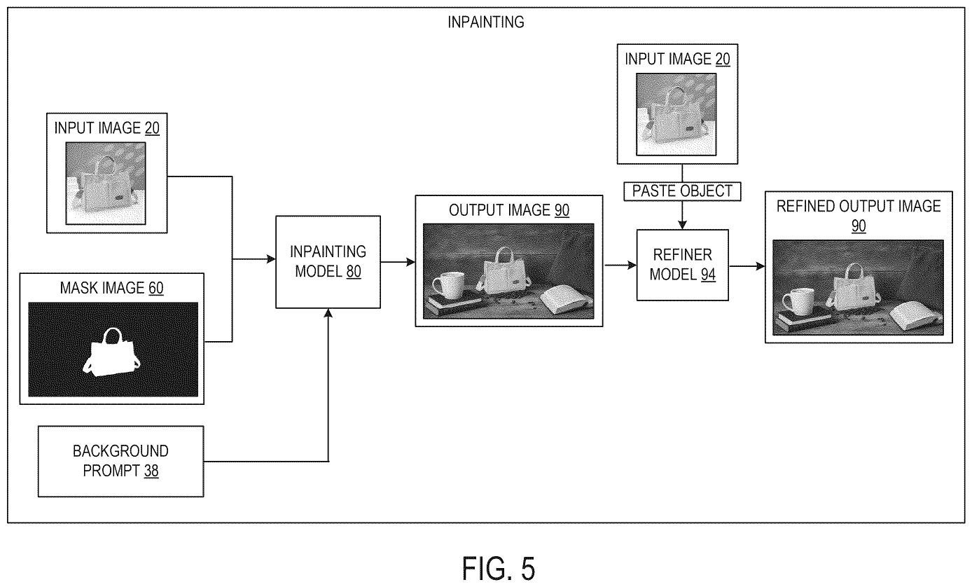

Turning back to FIG. 1, the processing circuitry 12 is further configured to inpaint, via an inpainting model 80, the infill region 62 based on the input image 20, the mask image 60, and the background prompt 38, to thereby generate the output image 90. FIG. 5 provides a detailed illustration of the inpainting process performed by the inpainting model 80. As shown in the figure, the input image 20, the mask image 60, and the background prompt 38, to thereby generate the output image 90 are input to the inpainting model 80 for background inpainting, where the infill region 62 has been inpainted. The inpainting model 80 is a type of AI model (e.g., BrushNet) designed to restore or fill in missing or corrupted parts of an image. Additionally, the output image 90 generated by the inpainting model may be refined by a refiner model 94 by carefully pasting the image of the object 22 into the output image 90 to thereby produce a refined output image 90. The output image 90 may be refined by preserving edge details of the object 22, enhancing the final output quality.

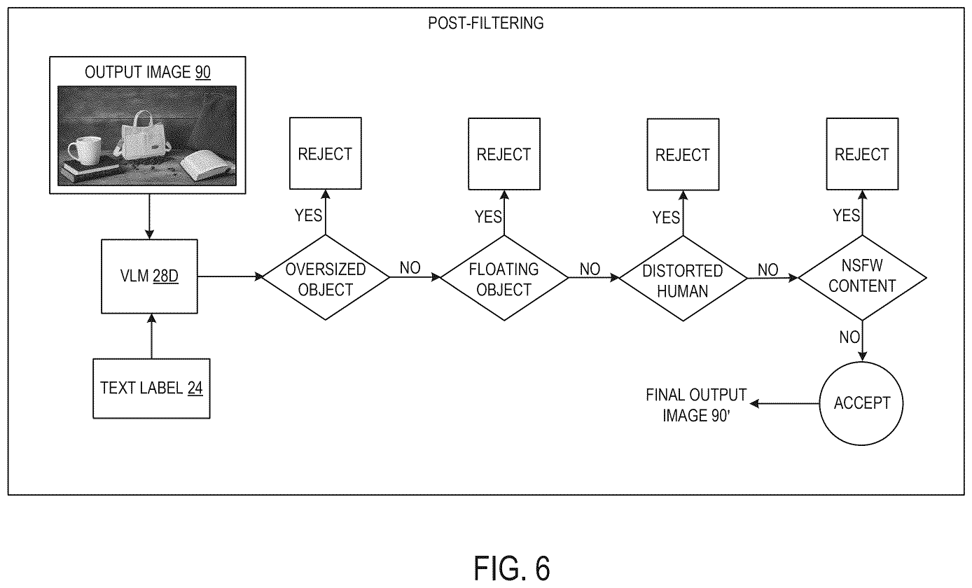

Turning back to FIG. 1, the processing circuitry 12 is configured to output the output image 90. The processing circuitry 12 is further configured to input the output image 90 to a post-filtering module 92 to evaluate qualities of the output image 90 to thereby generate the final output image. FIG. 6 provides a detailed illustration of the post-filtering process performed by the post-filtering module 92. The post-filtering process evaluates the output images 90 for realism, overall quality, non-safe content, distorted human forms, and visual appeal. The processing circuitry 12 is configured to input the output image 90 and the text label 24 to the VLM 28D to evaluate qualities of the output image 90. The processing circuitry 12 is further configured to accept or reject the output image based on the qualities of the output image 90 for various criteria. For example, as depicted in FIG. 6, the output image 90 is accepted or rejected depending on whether the output image 90 includes an oversized or floating object. The output image 90 is further accepted or rejected based on whether the output image 90 includes distorted human or not safe for work (NSFW) content. The output image 90 is further accepted or rejected based on the overall quality of the output image 90. This evaluation may be repeated until a satisfactory result is generated. Through this post-filtering process, only output images 90 that are accepted for all these factors can be utilized as the final output image 90′. Furthermore, it will be appreciated that this post-filtering process can be made optional and omitted.

The output image 90 may be utilized for advertisement. For example, the store owner can post the output image 90, featuring a bag, on a shopping website, platform, or application to sell the bag. Furthermore, A news media can use this system to generate the output image 90 to illustrate an article about the latest fashion trends, highlighting the featured bag as a popular accessory. Additionally, an individual can utilize the system to create the output image 90 as a family photo.

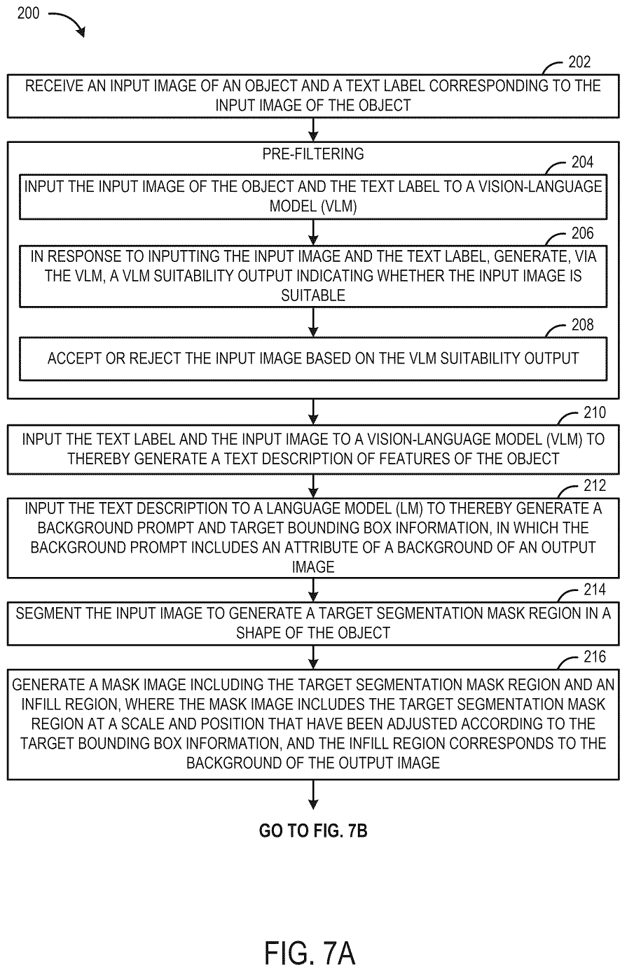

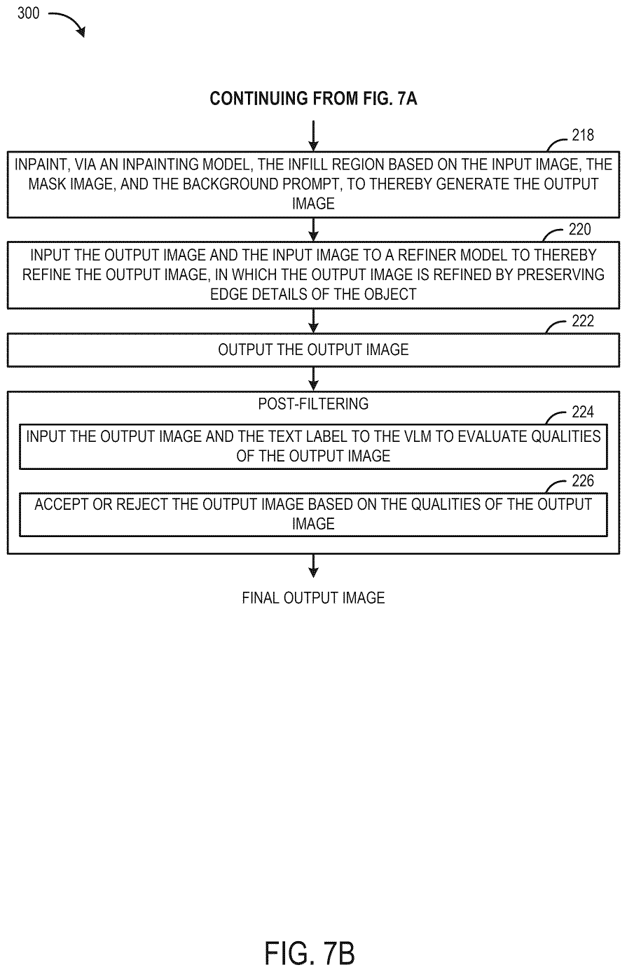

FIG. 7 shows a flowchart of a computerized method 200 according to one example implementation of the computing system 10 of FIG. 1. At step 202, the method may include receiving an input image of an object and a text label corresponding to the input image of the object.

At steps 204, 206, and 208, pre-filtering of the input image is performed. At step 304, the method may include inputting the input image of the object and the text label to a vision-language model (VLM). At step 206, the method may include, in response to inputting the input image and the text label, generating, via the VLM, a VLM suitability output indicating whether the input image is suitable. At step 208, the method may include accepting or rejecting the input image based on the VLM suitability output.

At step 210, the method may include inputting the text label and the input image to a vision-language model (VLM) to thereby generate a text description of features of the object.

At step 212, the method may include inputting the text description to a language model (LM) to thereby generate a background prompt and target bounding box information, in which the background prompt includes an attribute of a background of an output image.

At step 214, the method may include segmenting the input image to generate a target segmentation mask region in a shape of the object.

At step 216, the method may include generating a mask image including the target segmentation mask region and an infill region, where the mask image including the target segmentation mask region at a scale and position that have been adjusted according to the target bounding box information, and the infill region corresponds to the background of the output image.

Continuing to FIG. 7B, at step 218, the method may include inpainting, via an inpainting model, the infill region based on the input image, the mask image, and the background prompt, to thereby generate the output image.

At step 220, the method may include inputting the output image and the input image to a refiner model to thereby refine the output image, in which the output image is refined by preserving edge details of the object.

At step 222, the method may include outputting the output image.

At steps 224 and 226, post-filtering of the output image is performed. At step 224, the method may include inputting the output image and the text label to the VLM to evaluate qualities of the output image. At 226, the method may include accepting or rejecting the output image based on the qualities of the output image to thereby generate a final output image.

It will be appreciated that the above-described system and method provide an automated system for automatically generating high-quality product images, especially for advertising by integrating advanced technologies such as visual language models (VLMs), image segmentation tools, and inpainting networks. VLMs comprehend the brand and advertising context to ensure the images align with the brand's style. Segmentation tools isolate products from backgrounds for easier editing, while inpainting networks refine image details for a polished appearance. The above-described system and method offer the significant technical benefit of reducing the need for manual work and specialized design skills, thereby greatly enhancing the speed and quality of image production. With a 78% success rate in creating high-quality images with matching background images, the system and method consistently deliver attractive and diverse visuals.

In some embodiments, the methods and processes described herein may be tied to a computing system of one or more computing devices. In particular, such methods and processes may be implemented as a computer-application program or service, an application-programming interface (API), a library, and/or other computer-program product.

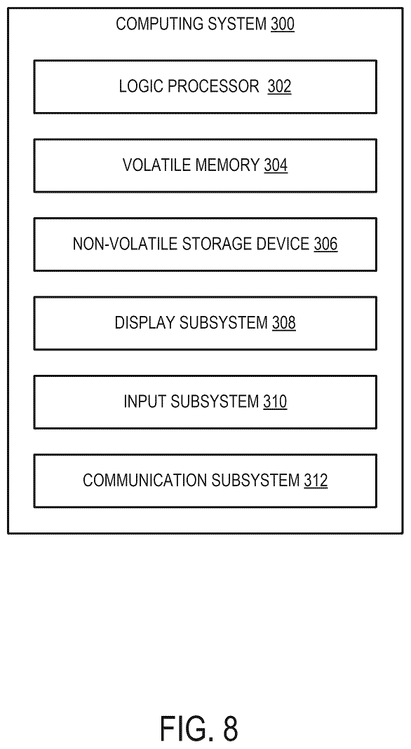

FIG. 8 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Computing system 300 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components not shown in FIG. 1.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built-in. Non-volatile storage device 306 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program-and application-specific integrated circuits (PASIC/ASICs), program-and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on-or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wireless telephone network, or a wired or wireless local-or wide-area network, such as a HDMI over Wi-Fi connection. In some embodiments, the communication subsystem may allow computing system 300 to send and/or receive messages to and/or from other devices via a network such as the Internet.

The following paragraphs provide additional description of the subject matter of the present disclosure. One aspect provides a computing system comprising processing circuitry and memory storing instructions that, during execution, cause the processing circuitry to receive an input image of an object. The processing circuitry is further configured to receive a text label corresponding to the input image of the object. The processing circuitry is further configured to input the text label and the input image to a vision-language model (VLM) to thereby generate a text description of features of the object. The processing circuitry is further configured to input the text description to a language model (LM) to thereby generate a background prompt and target bounding box information, where the background prompt includes an attribute of a background of an output image. The processing circuitry is further configured to segment the input image to generate a target segmentation mask region in a shape of the object. The processing circuitry is further configured to generate a mask image including the target segmentation mask region and an infill region, where the mask image includes the target segmentation mask region at a scale and position that have been adjusted according to the target bounding box information, and the infill region corresponds to the background of the output image. The processing circuitry is further configured to, in response to inputting the input image, generate, via the VLM, a VLM suitability output indicating whether the input image is suitable. The processing circuitry is further configured to accept or reject the input image based on the VLM suitability output. The processing circuitry is further configured to output the output image.

In this aspect, the processing circuitry is further configured to input the input image of the object and the text label to the VLM. The processing circuitry is further configured to, in response to inputting the input image, generate, via the VLM, a VLM suitability output indicating whether the input image is suitable. The processing circuitry is further configured to accept or reject the input image based on the VLM suitability output.

In this aspect, the text label is a product name.

In this aspect, the attribute of the background of the output image is selected from shot type, atmosphere, environment, and/or frame of the background.

In this aspect, the processing circuitry is further configured to input the output image and the input image to a refiner model to thereby refine the output image.

In this aspect, the output image is refined by preserving edge details of the object.

In this aspect, the processing circuitry is further configured to input the output image and the text label to the VLM to evaluate qualities of the output image. The processing circuitry is further configured to accept or reject the output image based on the qualities of the output image.

In this aspect, the output image is utilized for advertisement.

In this aspect, a target geographic location in addition to the text description is input to the language model (LM) to generate the background prompt and the target bounding box information.

Another aspect provides a computerized method. The method comprises receiving an input image of an object. The method further comprises receiving a text label corresponding to the input image of the object. The method further comprises, The method further comprises inputting the text label and the input image to a vision-language model (VLM) to thereby generate a text description of features of the object. The method further comprises inputting the text description to a language model (LM) to thereby generate a background prompt and target bounding box information, where the background prompt includes an attribute of a background of an output image. The method further comprises segmenting the input image to generate a target segmentation mask region in a shape of the object. The method further comprises generating a mask image including the target segmentation mask region and an infill region, where the mask image includes the target segmentation mask region at a scale and position that have been adjusted according to the target bounding box information, and the infill region corresponds to the background of the output image. The method further comprises inpainting, via an inpainting model, the infill region based on the input image, the mask image, and the background prompt, to thereby generate the output image. The method further comprises outputting the output image.

In this aspect, the method further comprises inputting the input image of the object and the text label to the vision-language model (VLM). The method further comprises, in response to inputting the input image and the text label, generating, via the VLM, a VLM suitability output indicating whether the input image is suitable. The method further comprises accepting or rejecting the input image based on the VLM suitability output.

In this aspect, the text label is a product name.

In this aspect, the attribute of the background of the output image is selected from shot type, atmosphere, environment, and/or frame of the background.

In this aspect, the method further comprises inputting the output image and the input image to a refiner model to thereby refine the output image.

In this aspect, the output image is refined by preserving edge details of the object.

In this aspect, the method further comprises inputting the output image and the text label to the VLM to evaluate qualities of the output image. The method further comprises accepting or rejecting the output image based on the qualities of the output image.

In this aspect, the output image is utilized for advertisement.

In this aspect, a target geographic location in addition to the text description is input to the language model (LM) to generate the background prompt and the target bounding box information.

Another aspect provides a non-transitory computer readable medium including instructions stored thereon. In this aspect, the instructions, when executed by processing circuitry, cause the processor to execute the following steps. The processor is configured to receive an input image of an object. The processor is further configured to receive a text label corresponding to the input image of the object. The processor is further configured to input the text label and the input image to a vision-language model (VLM) to thereby generate a text description of features of the object. The processor is further configured to input the text description to a language model (LM) to thereby generate a background prompt and target bounding box information, where the background prompt includes an attribute of a background of an output image. The processor is further configured to segment the input image to generate a target segmentation mask region in a shape of the object. The processor is further configured to generate a mask image including the target segmentation mask region and an infill region, where the mask image includes the target segmentation mask region at a scale and position that have been adjusted according to the target bounding box information, and the infill region corresponds to the background of the output image. The processor is further configured to inpaint, via an inpainting model, the infill region based on the input image, the mask image, and the background prompt, to thereby generate the output image. The processor is further configured to output the output image.

In this aspect, the attribute of the background of the output image is selected from shot type, atmosphere, environment, and/or frame of the background.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
processing circuitry and memory storing instructions that, during execution, cause the processing circuitry to:
receive an input image of an object;
receive a text label corresponding to the input image of the object;
input the text label and the input image to a vision-language model (VLM) to thereby generate a text description of features of the object;
input the text description to a language model (LM) to thereby generate a background prompt and target bounding box information, the background prompt including an attribute of a background of an output image;
segment the input image to generate a target segmentation mask region in a shape of the object;
generate a mask image including the target segmentation mask region and an infill region, the mask image including the target segmentation mask region at a scale and position that have been adjusted according to the target bounding box information, the infill region corresponding to the background of the output image;
inpaint, via an inpainting model, the infill region based on the input image, the mask image, and the background prompt, to thereby generate the output image; and
output the output image.

2. The computing system of claim 1, wherein the processing circuitry is further configured to:
input the input image of the object and the text label to the VLM,
in response to inputting the input image, generate, via the VLM, a VLM suitability output indicating whether the input image is suitable; and
accept or reject the input image based on the VLM suitability output.

3. The computing system of claim 1, wherein the text label is a product name.

4. The computing system of claim 1, wherein
the attribute of the background of the output image is selected from shot type, atmosphere, environment, and/or frame of the background.

5. The computing system of claim 1, wherein the processing circuitry is further configured to:
input the output image and the input image to a refiner model to thereby refine the output image.

6. The computing system of claim 5, wherein the output image is refined by preserving edge details of the object.

7. The computing system of claim 1, wherein the processing circuitry is further configured to:
input the output image and the text label to the VLM to evaluate qualities of the output image; and
accept or reject the output image based on the qualities of the output image.

8. The computing system of claim 1, wherein
the output image is utilized for advertisement.

9. The computing system of claim 1, wherein
a target geographic location in addition to the text description is input to the language model (LM) to generate the background prompt and the target bounding box information.

10. A computerized method, comprising:
receiving an input image of an object;
receiving a text label corresponding to the input image of the object;
inputting the text label and the input image to a vision-language model (VLM) to thereby generate a text description of features of the object;
inputting the text description to a language model (LM) to thereby generate a background prompt and target bounding box information, the background prompt including an attribute of a background of an output image;
segmenting the input image to generate a target segmentation mask region in a shape of the object;
generating a mask image including the target segmentation mask region and an infill region, the mask image including the target segmentation mask region at a scale and position that have been adjusted according to the target bounding box information, the infill region corresponding to the background of the output image;
inpainting, via an inpainting model, the infill region based on the input image, the mask image, and the background prompt, to thereby generate the output image; and
outputting the output image.

11. The computerized method of claim 10, further comprising:
inputting the input image of the object and the text label to the vision-language model (VLM),
in response to inputting the input image and the text label, generating, via the VLM, a VLM suitability output indicating whether the input image is suitable; and
accepting or rejecting the input image based on the VLM suitability output.

12. The computerized method of claim 10, wherein the text label is a product name.

13. The computerized method of claim 10, wherein
the attribute of the background of the output image is selected from shot type, atmosphere, environment, and/or frame of the background.

14. The computerized method of claim 10, further comprising:
inputting the output image and the input image to a refiner model to thereby refine the output image.

15. The computerized method of claim 10, wherein
the output image is refined by preserving edge details of the object.

16. The computerized method of claim 10, further comprising:
inputting the output image and the text label to the VLM to evaluate qualities of the output image; and
accepting or rejecting the output image based on the qualities of the output image.

17. The computerized method of claim 10, wherein the output image is utilized for advertisement.

18. The computerized method of claim 10, wherein
a target geographic location in addition to the text description is input to the language model (LM) to generate the background prompt and the target bounding box information.

19. A non-transitory computer readable medium including instructions stored thereon, the instructions, when executed by processing circuitry, causing the processor to execute steps of:
receiving an input image of an object;
receiving a text label corresponding to the input image of the object;
inputting the text label and the input image to a vision-language model (VLM) to thereby generate a text description of features of the object;
inputting the text description to a language model (LM) to thereby generate a background prompt and target bounding box information, the background prompt including an attribute of a background of an output image;
segmenting the input image to generate a target segmentation mask region in a shape of the object;
generating a mask image including the target segmentation mask region and an infill region, the mask image including the target segmentation mask region at a scale and position that have been adjusted according to the target bounding box information, the infill region corresponding to the background of the output image;
inpainting, via an inpainting model, the infill region based on the input image, the mask image, and the background prompt, to thereby generate the output image; and
outputting the output image.

20. The non-transitory computer readable medium of claim 19, wherein
the attribute of the background of the output image is selected from shot type, atmosphere, environment, and/or frame of the background.
